(19) United States
(12) Patent Application Publication
(10) Pub. No.: US 2022/0032880 A1
(43) Pub. Date: Feb. 3, 2022

(54) Windshield Scrubbing Assembly

(71) Applicant: Seth Southworth, Columbus, IN (US)

(72) Inventor: Seth Southworth, Columbus, IN (US)

(21) Appl. No.: 16/943,201

(22) Filed: Jul. 30, 2020

(51) Int. Cl. B60S 3/00

(52) U.S. Cl. CPC B60S 3/008

(57) ABSTRACT

A windshield scrubbing assembly for cleaning an interior surface of a windshield includes a wand that has a yoke on a distal end of the wand. A scrubbing unit is pivotally coupled to the yoke thereby facilitating the scrubbing unit to be positioned at a plurality of angles with respect to the wand. In this way the scrubbing unit can access an intersection between a lower threshold of a windshield of a vehicle and a dashboard of the vehicle. The scrubbing unit rotates when the scrubbing unit is turned on. A scrubbing pad is attachable to the scrubbing unit for scrubbing the interior surface of the windshield.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scrubbing devices and more particularly pertains to a new scrubbing device for scrubbing an interior surface of a vehicle windshield.

### (2) Description of Related Art Including Information Disclosed Under 37 CFR 1.97 and 1.98

The prior art relates to scrubbing devices including a telescopic wand that has a cleaning head mounted at a fixed angle with the wand. The prior art discloses a cleaning handle that has a scrubbing head that is removably clamped to the cleaning handle and which is oriented at an angle with the cleaning handle. The prior art discloses a cleaning handle that includes a cleaning head which is pivotally coupled to the cleaning handle and which is tightenable to be retained at a variety of angles with the cleaning handle. The prior art further discloses a scrubbing tool that includes a powered brush that extends laterally away from a handle for scrubbing a window. The prior art discloses a powered car washing device that includes a scrubbing head that is pivotally coupled to a handle and which includes light emitters.

### BRIEF SUMMARY OF THE INVENTION

An embodiment of the disclosure meets the needs presented above by generally comprising a wand that has a yoke on a distal end of the wand. A scrubbing unit is pivotally coupled to the yoke thereby facilitating the scrubbing unit to be positioned at a plurality of angles with respect to the wand. In this way the scrubbing unit can access an intersection between a lower threshold of a windshield of a vehicle and a dashboard of the vehicle. The scrubbing unit rotates when the scrubbing unit is turned on. A scrubbing pad is attachable to the scrubbing unit for scrubbing the interior surface of the windshield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom view of a windshield scrubbing assembly according to an embodiment of the disclosure.

FIG. 2 is a front view of an embodiment of the disclosure.

FIG. 3 is a left side view of an embodiment of the disclosure.

FIG. 4 is a right side view of an embodiment of the disclosure.

FIG. 5 is a top view of an embodiment of the disclosure.

FIG. 6 is a bottom view of an embodiment of the disclosure.

FIG. 7 is a perspective in-use view of an embodiment of the disclosure.

### DETAILED DESCRIPTION OF THE INVENTION

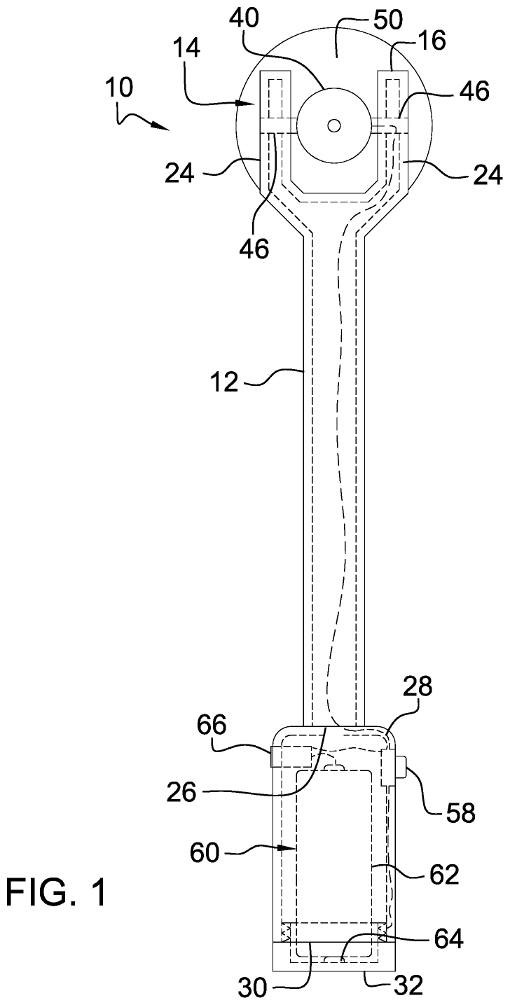

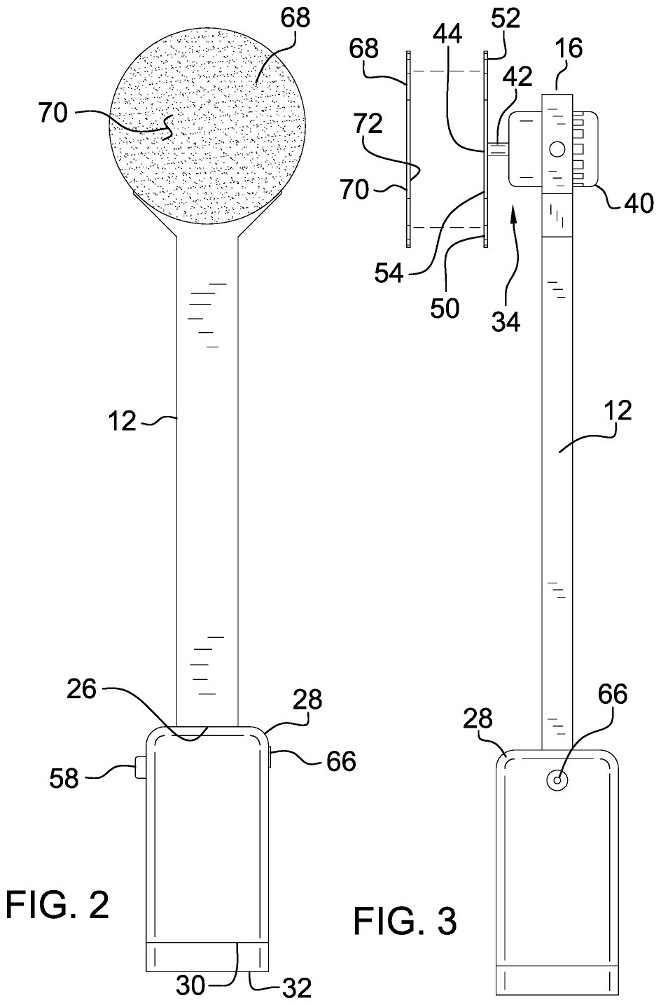

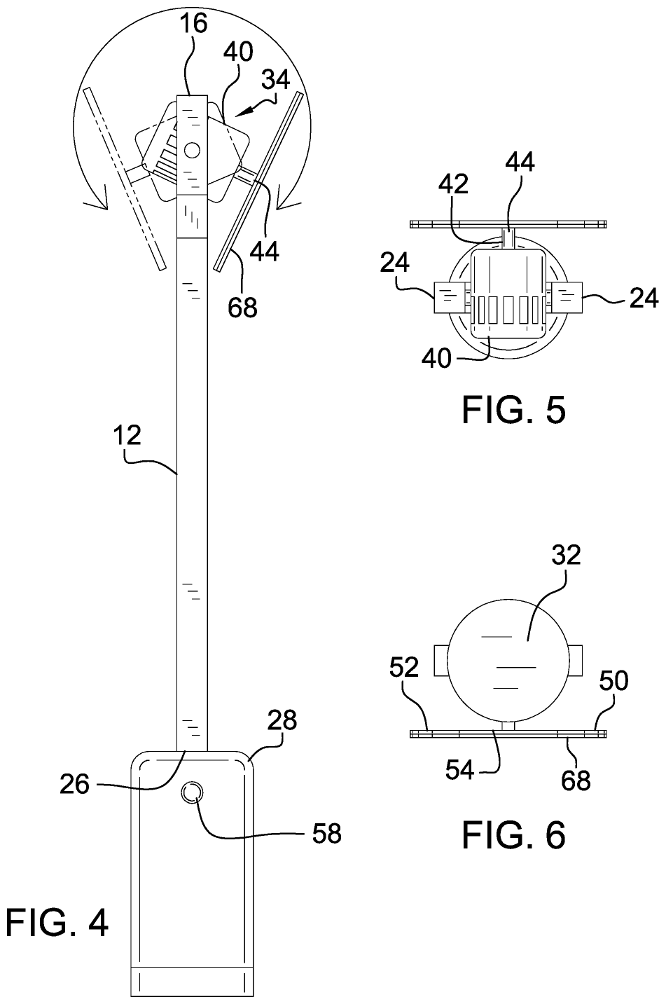

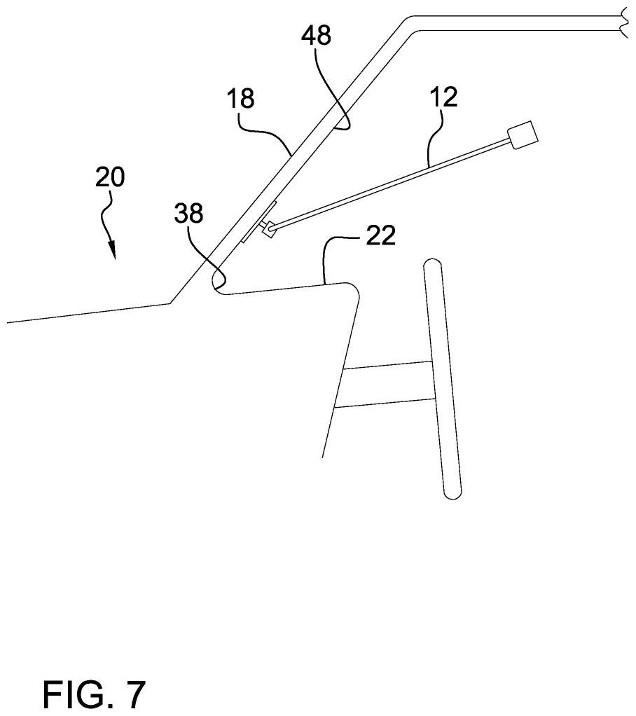

With reference now to the drawings, and in particular to FIGS. 1 through 7 thereof, a new scrubbing device embodying the principles and concepts of an embodiment of the disclosure and generally designated by the reference numeral 10 will be described.

As best illustrated in FIGS. 1 through 7, the windshield scrubbing assembly 10 generally comprises a wand 12 that has a yoke 14 on a distal end 16 of the wand 12. The wand 12 is gripped to facilitate the yoke 14 to be positioned between a windshield 18 of a vehicle 20 and a dashboard 22 of the vehicle 20. The vehicle 20 may be a passenger vehicle, a cargo vehicle or any other vehicle that has a windshield and a dashboard which join at an angle that is difficult to access by hand. The distal end 16 is forked to define respective arms 24 of the yoke 14 and the wand 12 has a coupled end 26. A housing 28 is coupled to the wand 12 and the housing 28 is positioned on the coupled end 26 of the wand 12. The housing 28 has a distal end 30 with respect to the coupled end 26 and the distal end 30 of the housing 28 is open. A cover 32 is removably coupled to the distal end 30 of the housing 28 for closing the distal end 30 of the housing 28.

A scrubbing unit 34 is pivotally coupled to the yoke 14 thereby facilitating the scrubbing unit 34 to be positioned at a plurality of angles with respect to the wand 12. In this way the scrubbing unit 34 can access an intersection between a lower threshold 38 of the windshield 18 and the dashboard 22. Additionally, the scrubbing unit 34 rotates when the scrubbing unit 34 is turned on. The scrubbing unit 34 comprises a motor 40 that has a drive shaft 42 which is rotatably coupled thereto. The drive shaft 42 is rotated in a first direction when the motor 40 is turned on and the drive shaft 42 has a distal end 44 with respect to the motor 40.

The scrubbing unit 34 includes a pair of couplings 46 that is each coupled to and extends laterally away from the motor 40 in opposite directions from each other. Each of the couplings 46 pivotally engages a respective one of the arms 24 of the yoke 14 such that the motor 40 is positioned between the arms 24 of the yoke 14. The drive shaft 42 is oriented to extend along a line that is oriented perpendicular to a line extending through each of the couplings 46. The motor 40 is rotatable about the line extending through each of the couplings 46 to adjust to a variety of angles between the wand 12 and the interior surface 48 of the windshield 18.

The scrubbing unit 34 includes a disk 50 that has a first surface 52 and a second surface 54, and the distal end 44 of the drive shaft 42 is coupled to the first surface 52. The drive shaft 42 is centrally positioned on the disk 50 and the disk 50 is rotated about the drive shaft 42 when the motor 40 is turned on. The scrubbing unit 34 includes a power button 58 that is movably coupled to the housing 28, and the power button 58 is electrically coupled to the motor 40 to turn the motor 40 on and off. The scrubbing unit 34 includes a power supply 60 that is positioned inside the housing 28 and the power supply 60 is electrically coupled to the power button 58.

The power supply 60 comprises a rechargeable battery 62 that is positioned in the housing 28 and the rechargeable battery 62 is electrically coupled to the power button 58. As is most clearly shown in FIG. 1, a contact 64 may be coupled to the cover 32 that electrically engages the rechargeable battery 62 when the cover 32 is attached to the housing 28 for completing the circuit between the power button 58 and the rechargeable battery 62. A charge port 66 is recessed into the housing 28 to receive a charge cord from a power source and the charge port 66 is electrically coupled to the rechargeable battery 62 for charging the rechargeable battery 62.

A scrubbing pad 68 is provided that is attachable to the scrubbing unit 34 to scrub the interior surface 48 of the windshield 18. The scrubbing pad 68 has a front surface 70 and a back surface 72. The back surface 72 engages the second surface 54 of the disk 50 for retaining the scrubbing pad 68 on the disk 50. In this way the front surface 70 scrubs the interior surface 48 of the windshield 18 when the motor 40 is turned on. The scrubbing pad 68 is comprised of a non-abrasive material such that the interior surface 48 of the windshield 18 is not scratched or damaged by the scrubbing pad 68.

In use, the scrubbing pad 68 is attached to the disk 50 and the wand 12 is gripped to position the motor 40 against the interior surface 48 of the windshield 18. Additionally, the pivotal coupling of the motor 40 facilitates the scrubbing pad 68 the scrub the windshield 18 at the intersection between the dashboard 22 and the windshield 18. In this way the interior surface 48 of the windshield 18 can be scrubbed at the location that would otherwise be inaccessible for manually scrubbing the windshield 18 by hand. The scrubbing pad 68 is maneuvered across the entire interior surface 48 of the windshield 18 for cleaning the interior surface 48 and subsequently improving vision for a driver of the vehicle 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A windshield scrubbing assembly for cleaning an interior surface of a windshield of a vehicle, said assembly comprising:
a wand having a yoke on a distal end of said wand wherein said yoke is configured to be positioned between a windshield of a vehicle and a dashboard of the vehicle;
a scrubbing unit being pivotally coupled to said yoke thereby facilitating said scrubbing unit to be positioned at a plurality of angles with respect to said wand wherein said scrubbing unit is configured to access an intersection between a lower threshold of the windshield and the dashboard, said scrubbing unit rotating when said scrubbing unit is turned on; and
a scrubbing pad being attachable to said scrubbing unit wherein said scrubbing pad is configured to scrub the interior surface of the windshield.

2. The assembly according to claim 1, further comprising:
a housing being coupled to said wand, said housing being positioned on said coupled end of said wand, said housing having a distal end with respect to said coupled end, said distal end of said housing being open; and
a cover being removably coupled to said distal end of said housing for closing said distal end of said housing.

3. The assembly according to claim 1, wherein said scrubbing unit comprises a motor having a drive shaft being rotatably coupled thereto, said drive shaft being rotated in a first direction when said motor is turned on, said drive shaft having a distal end with respect to said motor.

4. The assembly according to claim 2, further comprising a pair of couplings, each of said couplings being coupled to and extending laterally away from said motor in opposite directions from each other, each of said couplings pivotally engaging a respective one of said arms of said yoke such that said motor is positioned between said arms of said yoke, said drive shaft being oriented to extend along a line being oriented perpendicular to a line extending through each of said couplings.

5. The assembly according to claim 4, wherein said motor is rotatable about said line extending through each of said couplings wherein said motor is configured to adjust to a variety of angles between said wand and the interior surface of the windshield.

6. The assembly according to claim 3, wherein said scrubbing unit includes a disk having a first surface and a second surface, said first surface having said distal end of said drive shaft being coupled thereto, said drive shaft being centrally positioned on said disk, said disk being rotated about said drive shaft when said motor is turned on.

7. The assembly according to claim 3, wherein said scrubbing unit includes a power button being movably coupled to said housing, said power button being electrically coupled to said motor, said power button turning said motor on and off.

8. The assembly according to claim 7, wherein said scrubbing unit includes a power supply being positioned inside said housing, said power supply being electrically coupled to said power button, said power supply comprises:
a rechargeable battery being positioned in said housing, said rechargeable battery being electrically coupled to said power button; and
a charge port being recessed into said housing wherein said charge port is configured to receive a charge cord from a power source, said charge port being electrically coupled to said rechargeable battery for charging said rechargeable battery.

9. The assembly according to claim 6, wherein said scrubbing pad has a front surface and a back surface, said back surface engaging said second surface of said disk for retaining said scrubbing pad on said disk wherein said front surface is configured to scrub the interior surface of the windshield.

10. A windshield scrubbing assembly for cleaning an interior surface of a windshield of a vehicle, said assembly comprising:
a wand having a yoke on a distal end of said wand wherein said yoke is configured to be positioned between a windshield of a vehicle and a dashboard of the vehicle, said distal end being forked to define respective arms of said yoke, said wand having a coupled end;
a housing being coupled to said wand, said housing being positioned on said coupled end of said wand, said housing having a distal end with respect to said coupled end, said distal end of said housing being open;
a cover being removably coupled to said distal end of said housing for closing said distal end of said housing;
a scrubbing unit being pivotally coupled to said yoke thereby facilitating said scrubbing unit to be positioned at a plurality of angles with respect to said wand wherein said scrubbing unit is configured to access an intersection between a lower threshold of the windshield and the dashboard, said scrubbing unit rotating when said scrubbing unit is turned on, said scrubbing unit comprising:
a motor having a drive shaft being rotatably coupled thereto, said drive shaft being rotated in a first direction when said motor is turned on, said drive shaft having a distal end with respect to said motor;
a pair of couplings, each of said couplings being coupled to and extending laterally away from said motor in opposite directions from each other, each of said couplings pivotally engaging a respective one of said arms of said yoke such that said motor is positioned between said arms of said yoke, said drive shaft being oriented to extend along a line being oriented perpendicular to a line extending through each of said couplings, said motor being rotatable about said line extending through each of said couplings wherein said motor is configured to adjust to a variety of angles between said wand and the interior surface of the windshield;
a disk having a first surface and a second surface, said first surface having said distal end of said drive shaft being coupled thereto, said drive shaft being centrally positioned on said disk, said disk being rotated about said drive shaft when said motor is turned on;
a power button being movably coupled to said housing, said power button being electrically coupled to said motor, said power button turning said motor on and off; and
a power supply being positioned inside said housing, said power supply being electrically coupled to said power button, said power supply comprising:
a rechargeable battery being positioned in said housing, said rechargeable battery being electrically coupled to said power button; and
a charge port being recessed into said housing wherein said charge port is configured to receive a charge cord from a power source, said charge port being electrically coupled to said rechargeable battery for charging said rechargeable battery; and
a scrubbing pad being attachable to said scrubbing unit wherein said scrubbing pad is configured to scrub the interior surface of the windshield, said scrubbing pad having a front surface and a back surface, said back surface engaging said second surface of said disk for retaining said scrubbing pad on said disk wherein said front surface is configured to scrub the interior surface of the windshield.
